(19) United States
(12) Patent Application Publication
(10) Pub. No.: US 2008/0225019 A1
(43) Pub. Date: Sep. 18, 2008

(54) Electronic ink pen structure with an immediate charging function

(76) Inventor: Bear Hsiung, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,270

(22) Filed: Jun. 18, 2007

(30) Foreign Application Priority Data
Mar. 14, 2007 (TW) 96108751

(51) Int. Cl. G06F 3/037; B43K 29/10

(52) U.S. Cl. 345/180; 401/195

(57) ABSTRACT

An electronic ink pen structure with an immediate charging function includes a casing, a refill, a light-emitting element, a double-layered capacitor, two conductive pieces, and a repositioning module. The refill is movably disposed in the casing, and has a pen nib on a front side that is exposed outside a front side of the casing. The light-emitting element is disposed in the casing, next to one side of the refill. The double-layered capacitor electrically connects with the light-emitting element. One side of each conductive piece is exposed outside the casing and the other side is disposed in the casing for electrically connecting with a positive side and a negative side of the electrode of the double-layered capacitor. The repositioning module is disposed between the light-emitting element and the double-layered capacitor, and the repositioning module has a magnetic repulsor for making the refill stay in its original position.

### BACKGROUND OF THE INVENTION

1. Field of the Invention

The present invention relates to an electronic ink pen structure, and particularly relates to an electronic ink pen structure with an immediate charging function.

2. Description of the Related Art

The feature of the tablet PC is that users can use a digital pen to write, draw or create something on the monitor of the tablet PC.

The tablet PC not only transforms the text that a user writes down on the monitor into computer text, but also the text that the user writes can be stored in the tablet PC and the user can search any text that the user wants to in the tablet PC. When the user writes something on the monitor, the monitor will display different thickness and variations such as brush strokes according to the weight setting of the digital pen on the monitor. The above-mentioned feature uses digital ink technology. Hence, users can put paper on an electronic notebook and use a digital ink pen to write down any text on the paper. Next, the text that the user writes on the paper can be transformed into digital data via identification software. Hence, any handwriting information can be stored quickly and shared with others.

Hence, the electronic notebook is like a writing pad in that the user can put any paper such as an A4 sized sheet of paper on the writing pad and use the digital ink pen to write on the paper. At the same time, the writing pad will sense and identify the user's handwriting and store the user's handwriting as an image file in a built-in memory card or a memory expansion card.

### SUMMARY OF THE INVENTION

One particular aspect of the present invention is to provide an electronic ink pen structure with an immediate charging function. The electronic ink pen structure has a repositioning module disposed between a light-emitting element and a double-layered capacitor. When the electronic ink pen structure is being used, the light-emitting element and the double-layered capacitor conduct electricity via a refill to drive the light-emitting element to move. When the electronic ink pen structure is not being used, the repositioning module generates a magnetic repulsor to electrically insulate the light-emitting element and the double-layered capacitor. Moreover, the double-layered capacitor can be charged in a very short time by matching the two conductive pieces and the double-layered capacitor.

In order to achieve the above-mentioned aspects, the present invention provides an electronic ink pen structure with an immediate charging function that includes a casing, a refill, a light-emitting element, a double-layered capacitor, two conductive pieces, and a repositioning module. The refill is movably disposed in the casing, and the refill has a pen nib formed on a front side thereof and exposed outside a front side of the casing. The light-emitting element is disposed in the casing and next to one side of the refill. The double-layered capacitor is electrically connected with the light-emitting element. One side of each conductive piece is exposed outside the casing and the other side of each conductive piece is disposed in the casing and electrically connects with a positive side of the electrode and a negative side of the electrode of the double-layered capacitor. The repositioning module is disposed between the light-emitting element and the double-layered capacitor. The repositioning module has a magnetic repulsor for making the refill stay at an original position.

The refill, the light-emitting element, the repositioning module, and the double-layered capacitor are matched together. Hence, when the electronic ink pen structure is not being used, power is not supplied to the light-emitting element. Therefore, the present invention reduces power use. Moreover, the present invention has an immediate charging function via the matching of the two conductive pieces and the double-layered capacitor.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is an exploded view of an electronic ink pen structure with an immediate charging function of the present invention;

FIG. 2 is a partial cross-sectional view of an electronic ink pen structure with an immediate charging function of the present invention at a non-conductive status; and

FIG. 3 is a partial cross-sectional view of an electronic ink pen structure with an immediate charging function of the present invention at a conductive status.

### DETAILED DESCRIPTION OF THE PREFERRED EMBODIMENTS

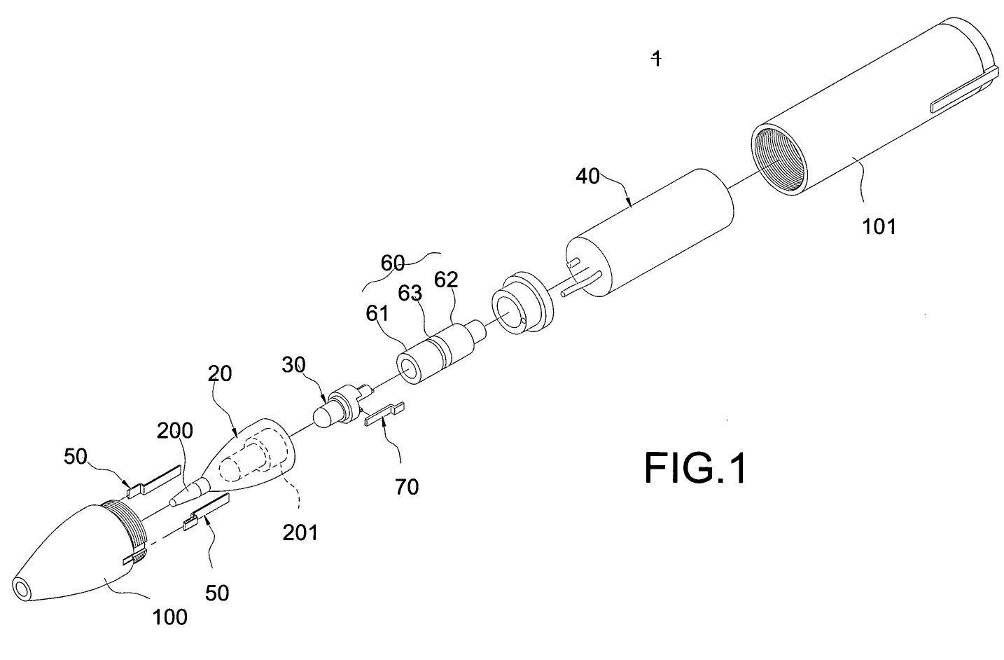

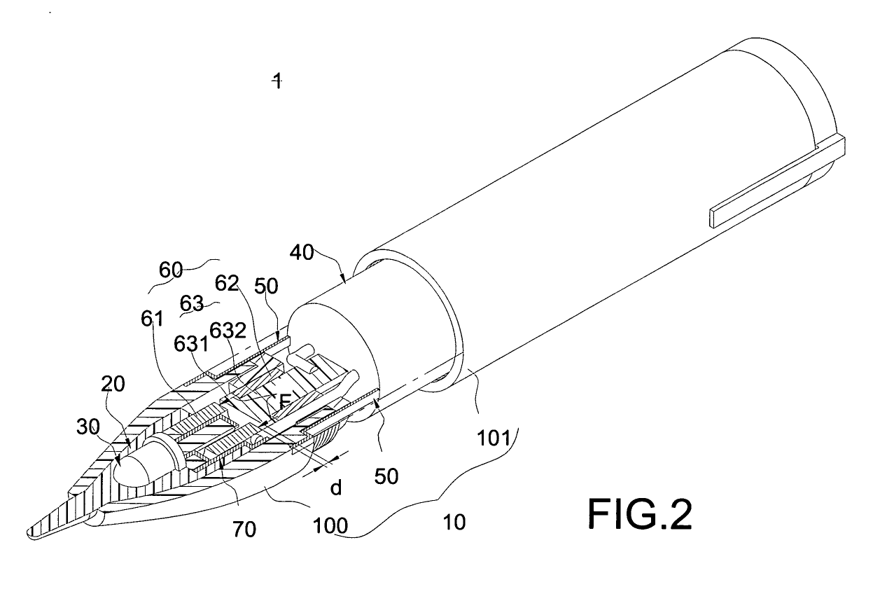

Referring to FIGS. 1 and 2 the present invention provides an electronic ink pen structure 1 with an immediate charging function that includes a casing 10, a refill 20, a light-emitting element 30, a double-layered capacitor 40, two conductive pieces 50, and a repositioning module 60.

The casing 10 is composed of a pen head 100 and a pen body 101. In the present embodiment, the pen head 100 and the pen body 101 are screwed together. Moreover, the refill 20, the light-emitting element 30, and the repositioning module 60 are disposed in the pen head 100. The double-layered capacitor 40 is disposed in the pen body 101.

The refill 20 is movably disposed in the casing 10. The refill 20 has a pen nib 200 formed on a front side thereof and exposed outside a front side of the casing 10. Furthermore, the refill 20 has a light-transmitting body, and the refill 20 has a receiving groove 201 formed on a rear side thereof for receiving the light-emitting element 30. Hence, in the present invention, the light-emitting element 30 is fixed in the receiving groove 201 so that the light-emitting element 30 and the refill 20 move simultaneously. In other words, when the refill 20 is moved, the light-emitting element 30 is relatively moved at the same time.

In addition, the light-emitting element 30 can be an LED or any light source. Because the light-emitting element 30 is disposed in the casing 10 and next to one side of the refill 20, the light source of the light-emitting element 30 passes through the refill 20 and is projected outwardly.

Moreover, the double-layered capacitor 40 is also known as a gold capacitor or a supercapacitor and has several advantages such as small size, large capacitance, and being capable of charging quickly. The double-layered capacitor 40 is electrically connected with the light-emitting element 30 for supplying power to the light-emitting element 30.

Furthermore, one side of each conductive piece 50 is exposed outside the casing 10 and the other side of each conductive piece 50 is disposed in the casing 10 for electrically connecting with a positive side of the electrode and a negative side of the electrode of the double-layered capacitor 40. Hence, when the electronic ink pen structure 1 is inserted into a charger (not shown in the Figure), the electronic ink pen structure 1 can be charged via two exposed sides of the two conductive pieces 50. In addition, the power source of the present invention is the double-layered capacitor 40, thus allowing the present invention to finish charging the electronic ink pen structure 1 in a very short time. In other words, when the electronic ink pen structure 1 is being used, the usage method of the electronic ink pen structure 1 is similar to that of a quill pen. Therefore, the charging process of the electronic ink pen structure 1 is similar to that of ancient times when a quill pen was soaked in ink before writing on a parchment.

In addition, the repositioning module 60 is disposed between the light-emitting element 30 and the double-layered capacitor 40. The repositioning module 60 is composed of a first magnet 61, a second magnet 62, and a metal element 63 disposed between the first magnet 61 and the second magnet 62. The metal element 63 is made of copper material or any conductive materials. The metal element 63 is composed of a first metal block 631 disposed between the first magnet 61 and the second magnet 62 and a second metal block 632 penetrating through the second magnet 62. The first metal block 631 has a thickness of between 0.5 mm and 1 mm.

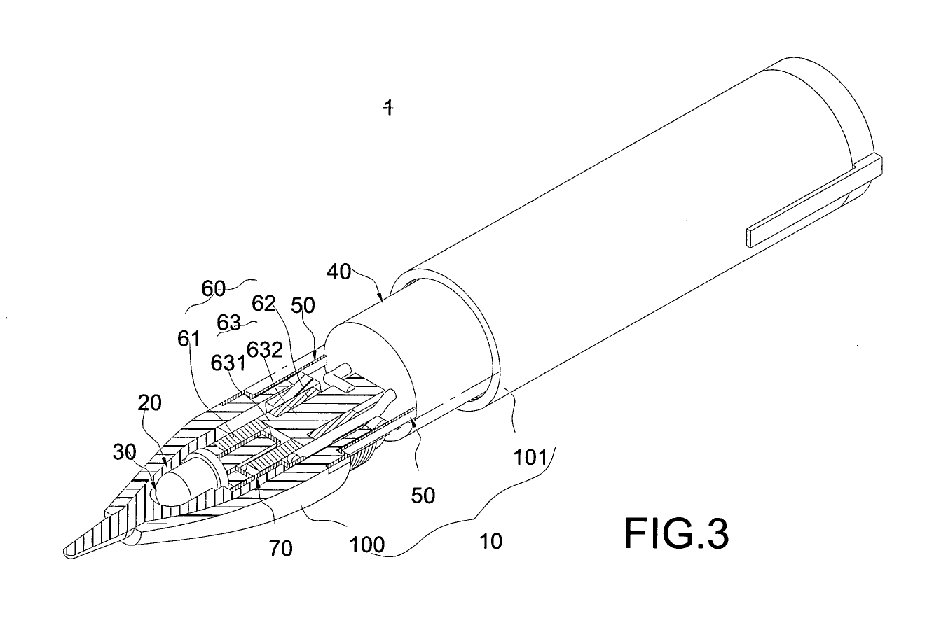

Referring to FIGS. 2 and 3, when the first magnet 61 and the refill 20 are simultaneously moved the metal element 63 abuts against the second magnet 62. The description of the first magnet 61 and the refill 20 being simultaneously moved means “the first magnet 61 selectively separates from the metal element 63 to a predetermined distance d or contacts the metal element 63”.

Such as can be seen in FIG. 2, when the first magnet 61 selectively separates from the metal element 63 to the predetermined distance d, the light-emitting element 30 is at power failure status. Such as can be seen in FIG. 3, when the first magnet 61 contacts the metal element 63 via the refill 20 pushing the first magnet 61, one side of an electrode (such as a positive side) of the double-layered capacitor 40 is electrically connected with one corresponding side of the electrode (such as the positive side) of the light-emitting element 30 through the metal element 63 and the first magnet 61 in sequence. Moreover, the other side of the electrode (such as a negative side) of the double-layered capacitor 40 is electrically connected with the other corresponding side of the electrode (such as the negative side) of the light-emitting element 30 via an inner conductive piece 70. Hence, the inner conductive piece 70 is electrically connected between one side of the electrode of the double-layered capacitor 40 and one corresponding side of the electrode of the light-emitting element 30.

In other words, the repositioning module 60 has a magnetic repulsor F for making the refill 20 stay at its original position. Hence, when the user has not used the electronic ink pen structure 1 yet (the refill 20 has not yet been pushed), the refill 20 stays in its original position via the magnetic repulsor F. Therefore, the light-emitting element 30 is at a power failure status. When the user uses the electronic ink pen structure 1, the refill 20 contacts a plane to generate an inward pushing force (not shown in the Fig.) for pushing the light-emitting element 30 to move. Because the inward push force is larger than the magnetic repulsor F, the light-emitting element 30 is electrically connected with the double-layered capacitor 40 through the first magnet 61 and the metal element 63 of the repositioning module 60.

In conclusion, the key feature of the present invention is that the repositioning module 60 is disposed between the light-emitting element 30 and the double-layered capacitor 40. When the electronic ink pen structure 1 is being used, the light-emitting element 30 and the double-layered capacitor 40 conduct electricity via the refill 20 to drive the light-emitting element 30 to move. When the electronic ink pen structure 1 is not being used, the repositioning module 60 generates the magnetic repulsor F to electrically insulate the light-emitting element 30 and the double-layered capacitor 40. Moreover, the double-layered capacitor 40 can be charged in a very short time via the matching of two conductive pieces 50 and the double-layered capacitor 40.

Moreover, the refill 20, the light-emitting element 30, the repositioning module 60, and the double-layered capacitor 40 are matched together. Hence, when the electronic ink pen structure 1 is not being used, power is not supplied to the light-emitting element 30. Therefore, the present invention reduces power use. Moreover, the present invention has an immediate charging function via the matching of the two conductive pieces 50 and the double-layered capacitor 40.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic ink pen structure with an immediate charging function, comprising:
a casing;
a refill movably disposed in the casing, wherein the refill has a pen nib formed on a front side thereof and exposed outside a front side of the casing;
a light-emitting element disposed in the casing and next to one side of the refill;
a double-layered capacitor electrically connected with the light-emitting element;
two conductive pieces, wherein one side of each conductive piece is exposed outside the casing and the other side of each conductive piece is disposed in the casing for electrically connecting with a positive side of the electrode and a negative side of the electrode of the double-layered capacitor; and
a repositioning module disposed between the light-emitting element and the double-layered capacitor, wherein the repositioning module has a magnetic repulsor for making the refill stay in its original position.

2. The electronic ink pen structure as claimed in claim 1, wherein the casing is composed of a pen head and a pen body.

3. The electronic ink pen structure as claimed in claim 2, wherein the refill, the light-emitting element, and the repositioning module are disposed in the pen head.

4. The electronic ink pen structure as claimed in claim 2, wherein the double-layered capacitor is disposed in the pen body.

5. The electronic ink pen structure as claimed in claim 1, wherein the refill has a light-transmitting body.

6. The electronic ink pen structure as claimed in claim 1, wherein the refill has a receiving groove formed on a rear side thereof for receiving the light-emitting element.

7. The electronic ink pen structure as claimed in claim 6, wherein the light-emitting element is fixed in the receiving groove, so that the light-emitting element and the refill move simultaneously.

8. The electronic ink pen structure as claimed in claim 1, wherein the light-emitting element is an LED.

9. The electronic ink pen structure as claimed in claim 1, wherein the repositioning module is composed of a first magnet, a second magnet, and a metal element disposed between the first magnet and the second magnet.

10. The electronic ink pen structure as claimed in claim 9, wherein the metal element is made of a copper material.

11. The electronic ink pen structure as claimed in claim 9, wherein the metal element is composed of a first metal block disposed between the first magnet and the second magnet, and a second metal block penetrating through the second magnet.

12. The electronic ink pen structure as claimed in claim 11, wherein the first metal block has a thickness of between 0.5 mm and 1 mm.

13. The electronic ink pen structure as claimed in claim 9, wherein the first magnet and the refill move simultaneously, and the metal element abuts against the second magnet.

14. The electronic ink pen structure as claimed in claim 13, wherein the first magnet selectively separates from the metal element to a predetermined distance or contacts the metal element.

15. The electronic ink pen structure as claimed in claim 14, wherein when the first magnet contacts the metal element, one side of the electrode of the double-layered capacitor is electrically connected with one corresponding side of the electrode of the light-emitting element through the metal element and the first magnet in sequence.

16. The electronic ink pen structure as claimed in claim 1, further comprising an inner conductive piece electrically connected between one side of the electrode of the double-layered capacitor and one corresponding side of the electrode of the light-emitting element.
